(19) United States
(12) Patent Application Publication
(10) Pub. No.: US 2013/0028296 A1
(43) Pub. Date: Jan. 31, 2013

(54) CHIP X2 CORRELATION HYPOTHESES USING CHIP X1 SAMPLES

(71) Applicants: Aamod D. Khandekar, San Diego, CA (US); Dario Fertonani, La Jolla, CA (US); Srikanth Gummadi, Secundarabad (IN)

(72) Inventors: Aamod D. Khandekar, San Diego, CA (US); Dario Fertonani, La Jolla, CA (US); Srikanth Gummadi, Secundarabad (IN)

(21) Appl. No.: 13/192,003

(22) Filed: Jul. 27, 2011

(51) Int. Cl. H04B 1/707

(52) U.S. Cl. 375/142; 375/E01.002

(57) ABSTRACT

A UE may store received samples of a wireless signal at cx1 to reduce memory usage, but then may correlate those samples with cx2 timing hypotheses to improve performance. The received sequence is resampled at cx2 instead of cx1. The UE still performs the correlation of the cx2 timing hypotheses for the performance gain, but the reference waveform is resampled with cx2 time offset. A Fast Fourier Transform (FFT) may be taken of the received and reference waveforms. In the frequency domain, resampling may be performed by multiplying the FFT of the reference waveform by a phase ramp—a pointwise multiplication in the frequency domain with a constant magnitude sequence whose phase varies linearly.

### BACKGROUND

1. Field

Aspects of the present disclosure relate, in general, to wireless communication systems, and more particularly, to correlating half-chip timing hypotheses using samples spaced apart by one-chip durations.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

A method for detecting a pilot sequence in a wireless communication system is offered. The method includes storing received samples of an input signal at a sample rate of chip x1. The method also includes correlating a reference sequence with a timing hypothesis finer than chip x1.

An apparatus for detecting a pilot sequence in a wireless communication system is offered. The apparatus includes means for storing received samples of an input signal at a sample rate of chip x1. The apparatus also includes means for correlating a reference sequence with a timing hypothesis finer than chip x1.

A computer program product for detecting a pilot sequence in a wireless communication system is offered. The computer program product includes a non-transitory computer-readable medium having non-transitory program code recorded thereon. The program code includes program code to store received samples of an input signal at a sample rate of chip x1. The program code also includes program code to correlate a reference sequence with a timing hypothesis finer than chip x1.

An apparatus for detecting a pilot sequence in a wireless communication system is offered. The apparatus includes a memory and a processor(s) coupled to the memory. The processor(s) is configured to store received samples of an input signal at a sample rate of chip x1. The processor(s) is also configured to correlate a reference sequence with a timing hypothesis finer than chip x1.

### BRIEF DESCRIPTION OF THE DRAWINGS

FIG. 1 is a block diagram illustrating an example of a telecommunications system.

FIG. 2 is a block diagram conceptually illustrating an example of a frame structure in a telecommunications system.

FIG. 3 is a block diagram of a Node B in communication with a user equipment in a radio access network.

FIG. 4 is a functional block diagram illustrating example blocks executed to implement one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

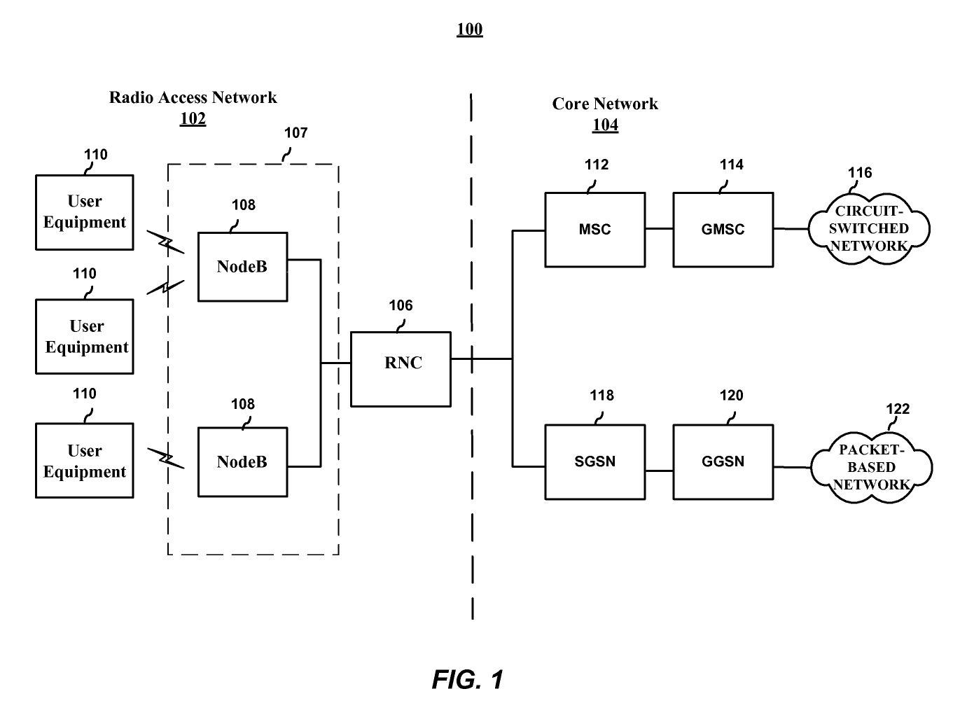

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (Radio Access Network) RAN 102 (e.g., UTRAN) that provides various wireless services including telephony, video, data, messaging, broadcasts, and/or other services. The RAN 102 may be divided into a number of Radio Network Subsystems (RNSs), such as an RNS 107, each controlled by a Radio Network Controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces, such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a Base Station (BS), a Base Transceiver Station (BTS), a radio base station, a radio transceiver, a transceiver function, a Basic Service Set (BSS), an Extended Service Set (ESS), an Access Point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a Session Initiation Protocol (SIP) phone, a laptop, a notebook, a netbook, a smartbook, a tablet, a Personal Digital Assistant (PDA), a satellite radio, a Global Positioning System (GPS) device, a multimedia device, a video device, a digital audio player (e.g., MP3 player), a camera, a game console, or any other similar functioning device. The mobile apparatus is commonly referred to as User Equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an Access Terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The Downlink (DL), also called the forward link, refers to the communication link from a Node B to a UE, and the Uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a Visitor Location Register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a Home Location Register (HLR) (not shown) containing subscriber data, such as the data reflecting the details of the services to which a particular user has subscribed. The HLR is also associated with an Authentication Center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a Serving GPRS Support Node (SGSN) 118 and a Gateway GPRS Support Node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a Time Division Duplexing (TDD), rather than a Frequency Division Duplexing (FDD) as used in many FDD mode UMTS/W-CDMA systems. TDD uses the same carrier frequency for both the Uplink (UL) and Downlink (DL) between a Node B 108 and a UE 110, but divides uplink and downlink transmissions into different time slots in the carrier.

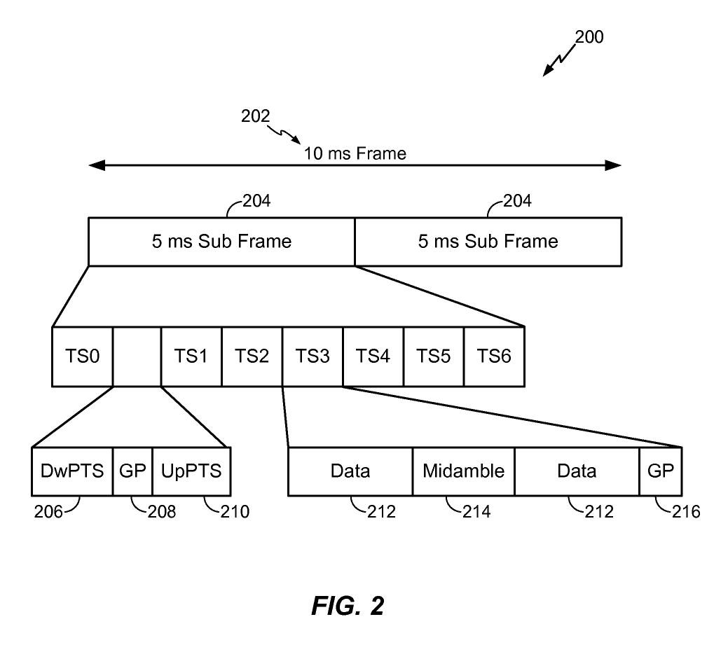

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A Downlink Pilot Time Slot (DwPTS) 206 (also known as the Downlink Pilot Channel (DwPCH)), a guard period (GP) 208, and an Uplink Pilot Time Slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a Guard Period (GP) 216. The midamble 214 may be used for features, such as channel estimation, while the GP 216 may be used to avoid inter-burst interference.

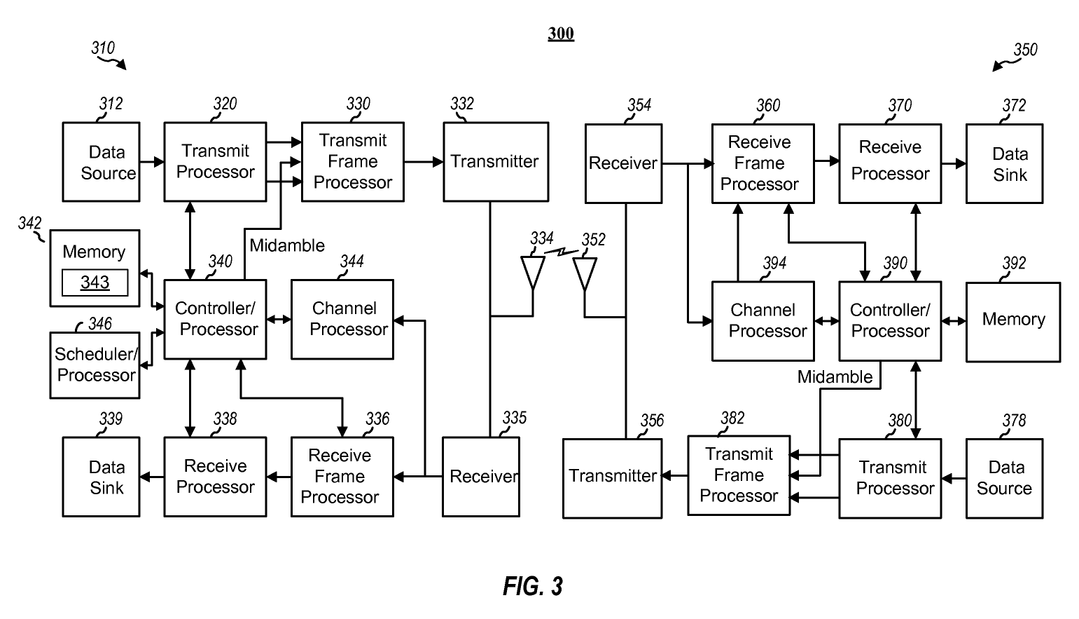

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide Cyclic Redundancy Check (CRC) codes for error detection, coding and interleaving to facilitate Forward Error Correction (FEC), mapping to signal constellations based on various modulation schemes (e.g., Binary Phase-Shift Keying (BPSK), Quadrature Phase-Shift Keying (QPSK), M-Phase-Shift Keying (M-PSK), M-Quadrature Amplitude Modulation (M-QAM), and the like), spreading with Orthogonal Variable Spreading Factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an Acknowledgement (ACK) and/or Negative Acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard, pointing device, track wheel, and the like). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the smart antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor 340, respectively. If some of the frames were unsuccessfully decoded by the receive processor 338, the controller/processor 340 may also use an Acknowledgement (ACK) and/or Negative Acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. For example, the memory 342 of the Node B 310 includes a handover module 343, which, when executed by the controller/processor 340, the handover module 343 configures the Node B to perform handover procedures from the aspect of scheduling and transmission of system messages to the UE 350 for implementing a handover from a source cell to a target cell. A scheduler/processor 346 at the Node B 310 may be used to allocate resources to the UEs and schedule downlink and/or uplink transmissions for the UEs not only for handovers, but for regular communications as well.

### Chip X2 Correlation Hypotheses Using Chip X1 Samples

When a UE wakes up from a sleep or power-off mode, the UE does not know what base station is transmitting, the cell ID of the base station, or the timing associated with the transmission. To carry out a search for an identifiable base station signal a UE may rely on correlation-based algorithms. Typically, a base station will transmit a pilot sequence, which may or may not be specific to that particular base station, and which repeats with a certain periodicity during a known portion of the communication frame. To connect to the base station the UE correlates with respect to the known pilot sequence with different timing or frequency hypotheses. Each timing hypothesis corresponds to a different potential timing for the serving base station. With the timing of the base station determined, the UE can commence normal communications with the base station.

To test whether the UE has chosen a timing hypothesis that matches the transmission timing of the base station, correlations are performed. Correlations are mathematical functions to determine how close the hypothesis (either timing or frequency) is to the received signal. When the UE's timing hypothesis matches the transmission timing of the base station, a high correlation will be recorded. A low correlation will typically be recorded at other timing hypotheses. To process received signals for correlation, the UE samples the received signals for analog-to-digital conversion at particular sample rates. An input signal may be sampled at a chip rate (also called chip x or cx), or at a multiple of a chip rate. A chip is a length of time based on the system transmission. A chip duration can be roughly thought of as the inverse of the system transmission bandwidth. A sample rate of cx1 (also called chip x1) is one times the chip rate, meaning the UE takes one sample of the input signal during each chip. A sample rate of cx2 is two times the chip rate, meaning the UE takes two samples of the input signal during each chip. Because a signal sampled at cx2 is sampled twice as often as a signal sampled at cx1, cx2 sampling results in higher resolution but also results in more processing power to obtain the sample and more memory dedicated to storing the sampled signal.

For base station timing acquisition, close-to-optimal performance can typically be achieved when the UE spaces its timing hypotheses apart by half-chip intervals by sampling at cx2. A significant loss may be seen when different timing hypotheses are spaced apart by one chip duration or larger. Using timing hypotheses at cx2 means each hypothesis shifts either the reference waveform (such as the pilot sequence) or received waveform by half a chip.

Even though the timing hypotheses are spaced apart by half-chip intervals (also known as chip x2 or cx2 hypotheses), the correlations themselves are typically carried out with samples spaced apart by one-chip (or cx1). This occurs because of complexity reasons. In particular, in most TDMA or CDMA systems, the pilot sequence is defined so that the sequence value is particularly simple when sampled at cx1. For example, the sequence may be a ±1 and/or a ±j sequence, or a rotated ±1 and/or ±j sequence. Correlation with such a sequence can be carried out with additions rather than multiplications, providing a substantial reduction in processing complexity.

In order to carry out correlations with a simple sequence, while still keeping cx2 timing hypotheses, received samples are typically stored at cx2. In some cases, this can lead to substantial memory usage, such as in a TD-SCDMA system. In this system, the pilot signal occurs once every 5 milliseconds (ms). In order to achieve desired performance, several subframes (for example, 8) worth of data are desired to achieve some combining gain. The resulting memory usage (5 ms*8=40 ms of data at cx2) can be large.

Offered is a method to reduce the memory usage for performing correlations with cx2 timing hypotheses. A UE may store received samples at cx1 instead of cx2. This will reduce the memory by a factor of two. To correlate those samples with cx2 timing hypotheses, the received sequence is then resampled at cx2 instead of cx1. To see this: Let yₖ be the cx2 received sequence and sₖ be the cx2 reference sequence. Suppose that the values s₂ₖ (i.e. the even phase of cx1 samples) consist of “simple” numbers (like ±1 or ±j) while the values s₂ₖ₊₁ (the odd phase of cx1 samples) are general complex numbers. The correlation is then computed at an even timing hypothesis 2n as sumₖ(y₂ₖ₊₂ₙs₂ₖ), and the correlation at a odd timing hypothesis 2n+1 as sumₖ(y₂ₖ₊₂ₙ₊₁s₂ₖ). As can be seen, this results in storing samples of the cx2 received sequence yₙ. An alternative way of computing the correlation is the following: compute the correlation at an even timing hypothesis 2n as before, but change the computation for the correlation at an odd timing hypothesis 2n+1 as sumₖ(y₂ₖ₊₂ₙ₊₂s₂ₖ₊₁). Now only even (i.e., cx1) samples of y are stored.

In this manner, instead of storing the received waveform in cx2 and performing the correlation in cx2, the received waveform may be stored in cx1. The UE still performs the correlation of the cx2 timing hypotheses for the performance gain, but the reference waveform is resampled with cx2 time offset. A Fast Fourier Transform (FFT) may be taken of the received and reference waveforms. In the frequency domain, resampling may be performed by multiplying the FFT of the reference waveform by a phase ramp—a pointwise multiplication in the frequency domain with a constant magnitude sequence with a linearly varying phase.

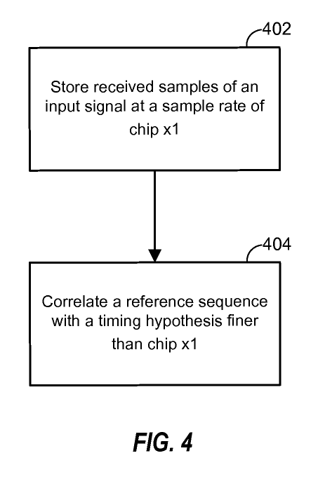

FIG. 4 is a functional block diagram illustrating example blocks executed to implement one aspect of the present disclosure. In block 402 received samples of an input signal are stored at a sample rate of chip x1. In block 404 a reference sequence is correlated with a timing hypothesis finer than chip x1.

In one configuration, the apparatus, for example the UE 350, for wireless communication includes means for storing received samples of an input signal at a sample rate of chip x1, and means for correlating a reference sequence with a timing hypothesis finer than chip x1. In one aspect, the aforementioned means for storing may be a data sink 372 and/or memory 392 configured to perform the functions recited by the aforementioned means. In one aspect, the aforementioned means for correlating may be a receive processor 370, data sink 372, controller/processor 390, and/or memory 392 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, Digital Signal Processor (DSP), a Field-Programmable Gate Array (FPGA), a Programmable Logic Device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., Compact Disc (CD), Digital Versatile Disc (DVD)), a smart card, a flash memory device (e.g., card, stick, key drive), Random Access Memory (RAM), Read Only Memory (ROM), Programmable ROM (PROM), Erasable PROM (EPROM), Electrically Erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for detecting a pilot sequence in a wireless communication system, the method comprising:
storing received samples of an input signal at a sample rate of chip x1; and
correlating a reference sequence with a timing hypothesis finer than chip x1.

2. The method of claim 1, further comprising sampling the reference sequence at a sample rate of chip x2.

3. The method of claim 1, further comprising:
sampling the reference sequence at a sample rate of chip x1; and
re-sampling the reference sequence at a sample rate of chip x2 during the correlating.

4. The method of claim 1 in which the correlation occurs in a time domain.

5. The method of claim 1 in which the correlation occurs in a frequency domain.

6. The method of claim 5 further comprising resampling by multiplying a Fast Fourier Transform of the received samples by a phase ramp.

7. An apparatus for detecting a pilot sequence in a wireless communication system, the apparatus comprising:
means for storing received samples of an input signal at a sample rate of chip x1; and
means for correlating a reference sequence with a timing hypothesis finer than chip x1.

8. The apparatus of claim 7, further comprising means for sampling the reference sequence at a sample rate of chip x2.

9. The apparatus of claim 7, further comprising:
means for sampling the reference sequence at a sample rate of chip x1; and
means for re-sampling the reference sequence at a sample rate of chip x2 during the correlating.

10. The apparatus of claim 7 in which the correlation occurs in a time domain.

11. A computer program product for detecting a pilot sequence in a wireless communication system, the computer program product comprising:
a non-transitory computer-readable medium having non-transitory program code recorded thereon, the program code comprising:
program code to store received samples of an input signal at a sample rate of chip x1; and
program code to correlate a reference sequence with a timing hypothesis finer than chip x1.

12. The computer program product of claim 11, further comprising program code to sample the reference sequence at a sample rate of chip x2.

13. The computer program product of claim 11, further comprising:
program code to sample the reference sequence at a sample rate of chip x1; and
program code to re-sample the reference sequence at a sample rate of chip x2 during the correlating.

14. The computer program product of claim 11 in which the correlation occurs in a time domain.

15. An apparatus for detecting a pilot sequence in a wireless communication system, the apparatus comprising:
a memory; and
at least one processor coupled to the memory, the at least one processor being configured:
to store received samples of an input signal at a sample rate of chip x1; and
to correlate a reference sequence with a timing hypothesis finer than chip x1.

16. The apparatus of claim 15, in which the at least one processor is further configured to sample the reference sequence at a sample rate of chip x2.

17. The apparatus of claim 15, in which the at least one processor is further configured:
to sample the reference sequence at a sample rate of chip x1; and
to re-sample the reference sequence at a sample rate of chip x2 during the correlating.

18. The apparatus of claim 15 in which the correlation occurs in a time domain.

19. The apparatus of claim 15 in which the correlation occurs in a frequency domain.

20. The apparatus of claim 19 further comprising resampling by multiplying a Fast Fourier Transform of the received samples by a phase ramp.
